(19) United States
(12) Patent Application Publication
(10) Pub. No.: US 2005/0262140 A1
(43) Pub. Date: Nov. 24, 2005

(54) Method and apparatus for argument parameterization of complex dataset operations

(76) Inventors: Barbara A. Christensen, Lino Lakes, MN (US); Eugene J. Gretter, Lino Lakes, MN (US); Michael J. Hill, Vadnais Heights, MN (US); John C. Horton, St. Paul, MN (US); Kenneth L. Reising, West St. Paul, MN (US)

Correspondence Address: UNISYS CORPORATION;MS 4773, PO BOX 64942, ST. PAUL, MN, 55164-0942, US

(21) Appl. No.: 10/849,470

(22) Filed: May 19, 2004

(51) Int. Cl. G06F 7/00

(52) U.S. Cl. 707/103 Y

(57) ABSTRACT

An apparatus for and method of utilizing an Internet terminal coupled to the world wide web to access a legacy data base management system having a dialog-based request format using a standardized object-based command language, such as JavaScript, rather than the proprietary command language native to the legacy data base management system. This approach leverages the power of the legacy data base management without the need for the user to become familiar with the proprietary command language of the legacy data base management system. The approach is particularly efficient in that the user can provide parameters to the legacy data base management system as a parameter object.

### CROSS REFERENCE TO CO-PENDING APPLICATIONS

U.S. patent application Ser. No. ______, filed ______, and entitled, “Method and Apparatus for Dataset Manipulation in a Javascript Environment”; U.S. patent application Ser. No. ______, filed ______, and entitled, “Cool ICE data Wizard”; U.S. patent application Ser. No. ______, filed ______, and entitled, “Cool ICE Column Profiling”; U.S. patent application Ser. No. ______, filed ______, and entitled, “Cool ICE OLEDB Consumer Interface”; and U.S. patent application Ser. No. ______, filed ______, and entitled, “Cool ICE State Management” are commonly assigned co-pending applications incorporated herein by reference.

### BACKGROUND OF THE INVENTION

1. Field of the Invention

The present invention generally relates to legacy data base management systems and more particularly relates to enhancements for providing access to such legacy data base management systems using a standardized object-based programming language.

2. Description of the Prior Art

Data base management systems are well known in the data processing art. Such commercial systems have been in general use for more than 20 years. One of the most successful data base management systems is available from Unisys Corporation and is called the Classic MAPPER® data base management system. The Classic MAPPER system can be reviewed using the Classic MAPPER User's Guide which may be obtained from Unisys Corporation.

The Classic MAPPER system, which runs on proprietary hardware also available from Unisys Corporation and on an industry compatible personal computer under a Windows Server operating system, provides a way for clients to partition data bases into structures called filing cabinets and drawers, as a way to offer a more tangible format. The BIS (Business Information System) data base manager utilizes various predefined high-level instructions whereby the data base user may manipulate the data base to generate human-readable data presentations called “reports”. The user is permitted to prepare lists of the various predefined high-level instructions into data base manager programs called “BIS Script”. Thus, users of the Classic MAPPER system may create, modify, and add to a given data base and also generate periodic and aperiodic reports using various BIS Script.

However, with the Classic MAPPER system, as well as with similar proprietary data base management systems, the user must interface with the data base using a terminal coupled directly to the proprietary system and must access and manipulate the data using the BIS Script command language of Classic MAPPER. Ordinarily, that means that the user must either be co-located with the hardware which hosts the data base management system or must be coupled to that hardware through dedicated telephone, satellite, or other data links. Furthermore, the user usually needs to be schooled in the command language of Classic MAPPER (or other proprietary data base management system) to be capable of generating BIS Script.

Since the advent of large scale, dedicated, proprietary data base management systems, the Internet or world wide web has come into being. Unlike closed proprietary data base management systems, the Internet has become a world wide bulletin board, permitting all to achieve nearly equal access using a wide variety of hardware, software, and communication protocols. Even though some standardization has developed, one of the important characteristics of the world wide web is its ability to constantly accept new and emerging techniques within a global framework. Many current users of the Internet have utilized several generations of hardware and software from a wide variety of suppliers from all over the world. It is not uncommon for current day young children to have ready access to the world wide web and to have substantial experience in data access using the Internet.

Thus, the major advantage of the Internet is its universality. Nearly anyone, anywhere can become a user. That means that virtually all persons are potentially Internet users without the need for specialized training and/or proprietary hardware and software. One can readily see that providing access to a proprietary data base management system, such as Classic MAPPER, through the Internet would yield an extremely inexpensive and universally available means for accessing the data which it contains and such access would be without the need for considerable specialized training.

There are two basic problems with permitting Internet access to a proprietary data base. The first is a matter of security. Because the Internet is basically a means to publish information, great care must be taken to avoid intentional or inadvertent access to certain data by unauthorized Internet users. In practice this is substantially complicated by the need to provide various levels of authorization to Internet users to take full advantage of the technique. For example, one might have a first level involving no special security features available to any Internet user. A second level might be for specific customers, whereas a third level might be authorized only for employees. One or more fourth levels of security might be available for officers or others having specialized data access needs.

Existing data base managers have security systems, of course. However, because of the physical security with a proprietary system, a certain degree of security is inherent in the limited access. On the other hand, access via the Internet is virtually unlimited which makes the security issue much more acute.

Current day security systems involving the world wide web involve the presentation of a user-id. Typically, this user-id either provides access or denies access in a binary fashion. To offer multiple levels of secure access using these techniques would be extraordinarily expensive and require the duplication of entire databases and or substantial portions thereof. In general, the advantages of utilizing the world wide web in this fashion to access a proprietary data base are directly dependent upon the accuracy and precision of the security system involved.

The second major problem is imposed by the Internet protocol itself. One of the characteristics of the Internet which makes it so universal is that any single transaction in HTML language combines a single transfer (or request) from a user coupled with a single response from the Internet server. In general, there is no means for linking multiple transfers (or requests) and multiple responses. In this manner, the Internet utilizes a transaction model which may be referred to as “stateless”. This limitation ensures that the Internet, its users, and its servers remain sufficiently independent during operation that no one entity or group of entities can unduly delay or “hang-up” the communications system or any of its major components. Each transmissions results in a termination of the transaction. Thus, there is no general purpose means to link data from one Internet transaction to another, even though in certain specialized applications limited amounts of data may be coupled using “cookies” or via attaching data to a specific HTML screen.

However, some of the most powerful data base management functions or services of necessity rely on coupling data from one transaction to another in dialog fashion. In fact this linking is of the essence of BIS Script which assume change of state from one command language statement to the next. True statelessness from a first BIS command to the next or subsequent BIS command would preclude much of the power of Classic MAPPER (or any other modern data base management system) as a data base management tool and would eliminate data base management as we now know it.

A further feature of the “state-managed” legacy data base management systems is the opportunity to define, initialize, and execute stored procedures. These are essentially software programs scripted in the command language of the data base management system which may be defined and later initialized and executed upon a subsequent occasion. The very concept of this functionality is inconsistent with the stateless operation of the Internet.

As explained above, even though the legacy data base management system can be made to interface with users via the Internet or other available network arrangement, the user is still required to functionally interface using the unique command language of the legacy data base management system. Quite often, younger users are schooled only in standardized object-based command languages.

### SUMMARY OF THE INVENTION

The present invention overcomes the disadvantages of the prior art by providing a method of and apparatus for efficiently utilizing the power of a full featured legacy data base management system by a user at a terminal coupled to the world wide web or Internet using a standardized object-based command language. In order to permit any such access, the present invention must first provide a user interface, called a gateway, which translates transaction data transferred from the user over the Internet in HTML format into a format from which data base management system commands and inputs may be generated. The gateway must also convert the data base management system responses and outputs into an HTML document for display on the user's Internet terminal. Thus, as a minimum, the gateway must make these format and protocol conversions. In the preferred embodiment, the gateway resides in the web server coupled to the user via the world wide web and coupled to proprietary data base management system.

To make access to a proprietary legacy data base by Internet users practical, a sophisticated security system is required to prevent intentional or inadvertent unauthorized access to the sensitive data of an organization. As discussed above, such a security system should provide multiple levels of access to accommodate a variety of authorized user categories. In the preferred embodiment of the present invention, rather than defining several levels of data classification, the different classes of users are managed by identifying a security profile as a portion of those service requests requiring access to secure data. Thus, the security profile accompanies the data/service to be accessed. The user simply need provide a user-id which correlates to the access permitted. This permits certain levels of data to be accessed by one or more of the several classes of user.

In the preferred mode of practicing the present invention, each user-id is correlated with a security profile. Upon preparation of the service request which provides Internet access to a given portion of the data base, the service request developer specifies which security profiles are permitted access to the data or a portion thereof. The service request developer can subsequently modify the accessibility of any security profile. The utility of the system is greatly enhanced by permitting the service request developer to provide access to predefined portions of the data, rather than being limited to permit or deny access to all of the data involved.

Whereas the gateway and the security system are the minimum necessary to permit the most rudimentary form of communication between the Internet terminal of the user and the proprietary data base management system, as explained above, the Internet is a “stateless” communication system; the addition of the gateway and the security system do not change this statelessness. To unleash the real power of the data base management system, the communication protocol between the data base and the user requires functional interaction between the various data transfers.

The present invention adds state management to this environment. Instead of considering each transfer from the Internet user coupled with the corresponding server response as an isolated transaction event as defined by the world wide web, one or more related service requests may be functionally associated in a service request sequence as defined by the data base management system into a dialog.

A repository is established to store the state of the service request sequence. As such, the repository can store intermediate requests and responses, as well as other data associated with the service request sequence. Thus, the repository buffers commands, data, and intermediate products utilized in formatting subsequent data base management service requests and in formatting subsequent HTML pages to be displayed to the user.

The transaction data in HTML format received by the server from the user, along with the state information stored in the repository, are processed by a service handler into a sequence of service requests in the command language of the data base management system. Sequencing and control of the data base management system is via an administration module.

Through the use of the repository to store the state of the service request sequence, the service handler to generate data base management command language, and the administration module, the world wide web user is capable of performing each and every data base management function available to any user, including a user from a proprietary terminal having a dedicated communication link which is co-located with the proprietary data base management system hardware and software. In addition, the data base management system user at the world wide web terminal is able to accomplish this in the HTML protocol, without extensive training concerning the command language of the data base management system.

In accordance with the preferred embodiment of the present invention, a new command, @SPI (stored procedure interface) is defined for the Business Information Server (BIS)/Cool ICE system. The new command has two primary modes of operation. First, the command provides the ability to execute a specified stored procedure and return the results. This includes the handling of rowsets, input variables, output variables, and input/output variables. Secondly, the command provides a method to query and return meta-data about stored procedures in a data base catalog. The meta-data will provide the available stored procedures as well as information about the parameters for the stored procedures.

Meta-data is data about data. It is a way of documenting datasets. The information contained in meta-data documents the creation of a dataset and gives an idea of what the cartographic product to which it is attached was designed to do.

Rowsets are the central objects that enable DB (data base) components to expose and manipulate data in tabular form. A rowset object is a set of rows in which each row has columns of data. For example, providers present data, as well as meta-data, to consumers in the form of rowsets. Query processors present query results in the form of rowsets. The use of rowsets throughout data base systems makes it possible to aggregate components that consume or produce data through the same object.

Without the present invention, the user must write the C code and make the proper API (Application Program Interface) calls to execute the stored procedure as well as handle input, output, and input/output variables. This is a difficult process and requires in depth knowledge of the data base API interface, in addition to the pitfalls of having to develop application code (memory allocation, pointer manipulation, configuring enough variable space, handling input/output variables, etc.). In addition to writing the application code and submitting the proper stored procedure command, users previously had no real mechanism to manipulate any data that is retrieved from the data source.

The present invention provides users the ability to execute a specified stored procedure as well as handle rowsets, input variables, output variables, and input/output variables without having to develop the application code themselves. Developing the code is a very cumbersome process with a lot of room for errors. Furthermore, the developer must be very knowledgeable concerning the API interface in order to correctly make proper calls.

In accordance with the preferred mode of the present invention, the user can access the underlying MAPPER data manipulation capabilities in a JavaScript object-based programming environment. Therefore, programmers knowledgeable in the practices of standard programming languages such as JavaScript can readily apply those skills to utilize the data manipulation and other capabilities derived from the underlying MAPPER engine. Each JavaScript represents a stored procedure of varying degrees of complexity that can be called from various development and application software within the product suite. Previously, these MAPPER engine capabilities were available using the proprietary MAPPER run-script procedural language.

In the preferred implementation, the JavaScript parser and objects are integrated into the MAPPER engine to support JavaScript stored procedures. The integrated JavaScript parser interprets and executes JavaScript stored procedures, which utilize custom JavaScript objects. These custom capabilities in an object-based paradigm for dataset manipulation and analysis purposes. Additional custom JavaScript objects are also provided to support the more complex MAPPER core engine “power” function analysis capabilities. JavaScript stored procedures are an alternative to BIS run-script, input and output arguments can be passed, and a resulting dataset can be returned to the caller, as well as an input dataset.

A key to making this process efficient is the technique for “parameterization” of the underlying MAPPER “power” commands. In order to leverage the more complex MAPPER core engine “power” function analysis capabilities, it is necessary for the programmer to supply a set of arguments. The arguments are positional and the number can range from none to many dozens. As the number of arguments increases, the burden of programming them can become unmanageable.

As originally conceived, the MAPPER engine power functions were invoked via the procedural BIS run-script language. This interface is satisfactory for programming simple sets of arguments, although it has the inherent disadvantage of requiring intricate knowledge of the proprietary BIS run-script language syntax. This syntax is very efficient, but at the tradeoff of being cryptic and therefore error prone and requiring specialized training. As the number of arguments increases, the programming task becomes daunting.

To compliment the JavaScript Dataset object, which represents a physical MAPPER database table, a suite of Parameter objects is provided to allow programming the numerous combinations of arguments that parameterize the processing performed by MAPPER core engine power function analysis functions. A separate JavaScript Parameter object is provided for each of the MAPPER core engine power functions. Each Parameter object contains custom properties, methods, and compound objects that conform to the programming requirements of a specific power function.

The present invention is preferable to prior art approaches because the parameterization of the MAPPER engine power functions is presented in a JavaScript object-based paradigm. This programming paradigm is readily discernable to programmers that are knowledgeable in modern programming languages and disciplines. Furthermore, it does not require programming knowledge in the proprietary MAPPER procedural run-script language. In addition, it allows programming of the underlying MAPPER engine power function data manipulation, aggregation, and analysis capabilities to be written and structured in an object-based paradigm. Therefore, such programs are easier for other programmers to comprehend enhance, and maintain.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a pictographic view of the hardware of the preferred embodiment;

FIG. 2 is a detailed flow diagram showing integration of the MAPPER engine with the JavaScript procedures;

FIG. 3 is listing of the script for a typical function;

FIG. 4 is a listing of the script for value-add power functions;

FIG. 5 is listing of a typical search parameter object;

FIG. 6 is a listing of the JavaScript to perform a search utilizing the search parameter object of FIG. 5; and

FIG. 7 is a listing if the BIS script prepared in accordance with the JavaScript of FIG. 6, along with the resultant report after performance of the search.

### DETAILED DESCRIPTION OF THE PREFERRED EMBODIMENTS

The present invention is described in accordance with several preferred embodiments which are to be viewed as illustrative without being limiting. These several preferred embodiments are based upon Series 2200 hardware and operating systems, the Classic MAPPER data base management system, and the BIS/Cool ICE software components, all available from Unisys Corporation. Also commercially available are industry standard personal computers operating in a Windows environment.

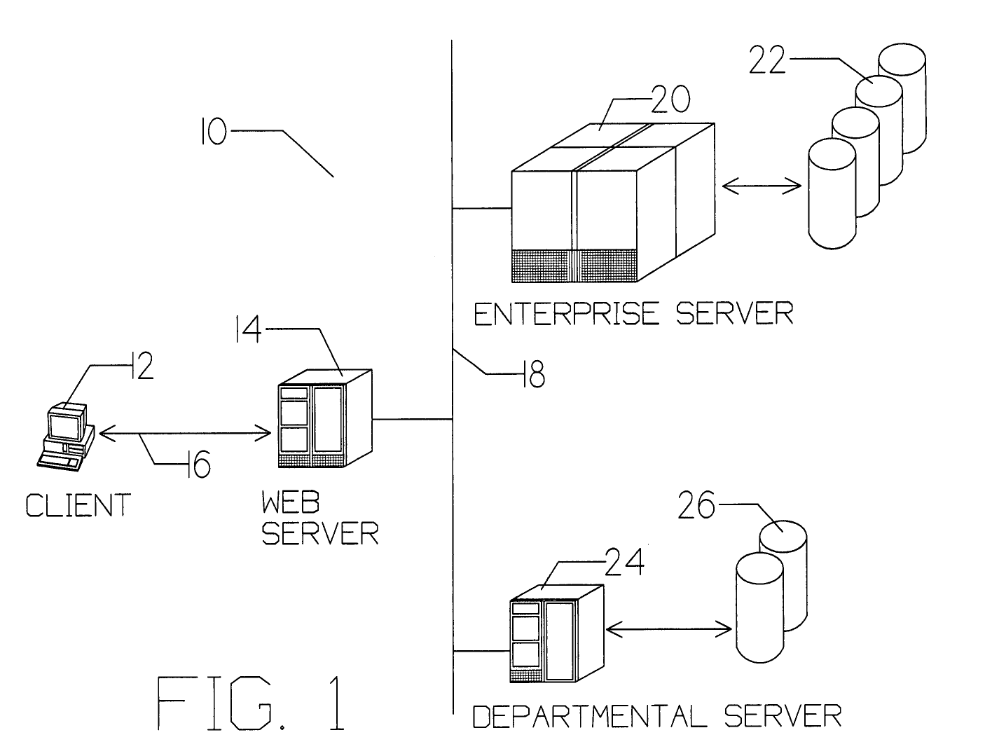

FIG. 1 is a pictorial diagram of hardware suite 10 of the preferred embodiment of the present invention. The client interfaces with the system via Internet terminal 12. Preferably, Internet terminal 12 is an industry compatible, personalized computer having a current version of the Windows operating system and suitable web browser, all being readily available commercial products. Internet terminal 12 communicates over world wide web access 16 using standardized HTML protocol, via Web Server 14.

The BIS/Cool ICE system is resident in Enterprise Server 20 and accompanying storage subsystem 22, which is coupled to Web Server 14 via WAN (Wide Area Network) 18. In the preferred mode, Web Server 14 is owned and operated by the enterprise owning and controlling the proprietary legacy data base management system. Web Server 14 functions as the Internet access provider for Internet terminal 12 wherein world wide web access 16 is typically a dial-up telephone line. This would ordinarily be the case if the shown client were an employee of the enterprise. On the other hand, web server 14 may be a remote server site on the Internet if the shown client has a different Internet access provider. This would ordinarily occur if the shown client were a customer or guest.

In addition to being coupled to WAN 18, Enterprise Server 20, containing the BIS/Cool ICE system, is coupled to departmental server 24 having departmental server storage facility 26. Additional departmental servers (not shown) may be similarly coupled. The enterprise data and enterprise data base management service functionality typically resides within enterprise server 20, departmental server 24, and any other departmental servers (not shown). Normal operation in accordance with the prior art would provide access to this data and data base management functionality.

In the preferred mode of the present invention, access to this data and data base management functionality is also provided to users (e.g., Internet terminal 12) coupled to Intranet 18. As explained below in more detail, web server 14 provides this access utilizing the BIS/Cool ICE system.

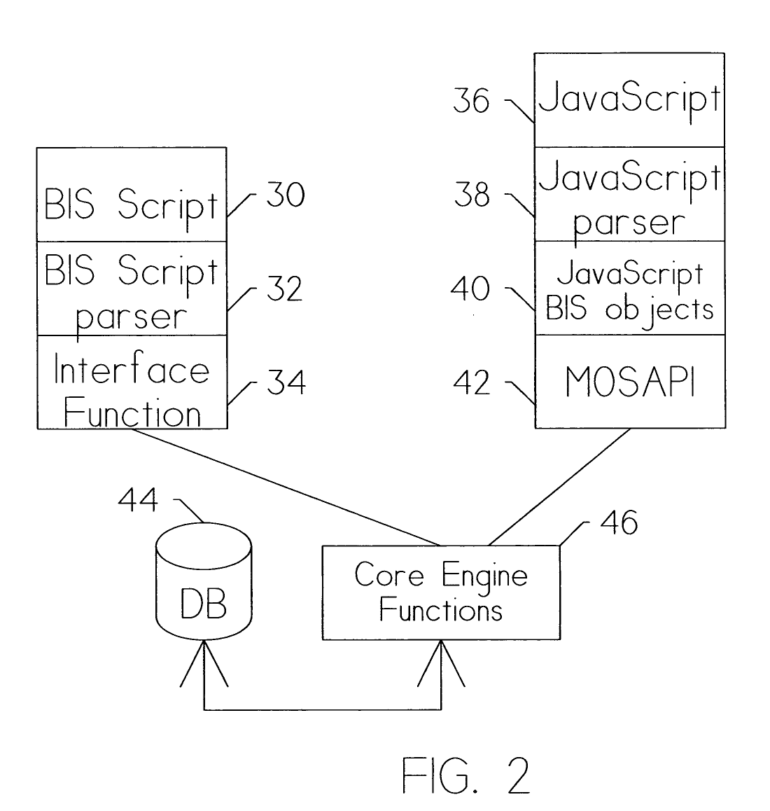

FIG. 2 is a detailed flow diagram showing integration of JavaScript with the MAPPER engine. In accordance with the preferred mode of the present invention, JavaScript 36 is presented to JavaScript parser 38 for processing. As a result, JavaScript BIS objects 40 are created for MOSAPI 42, which interfaces with Core Engine Functions 46.

Similarly, BIS script 30 is provided to BIS script parser 32 for initial processing. Interface function 34 presents an equivalent interface to Core Engine Functions 46. In either case, access to DataBase 44 is made by Core Engine Functions 46.

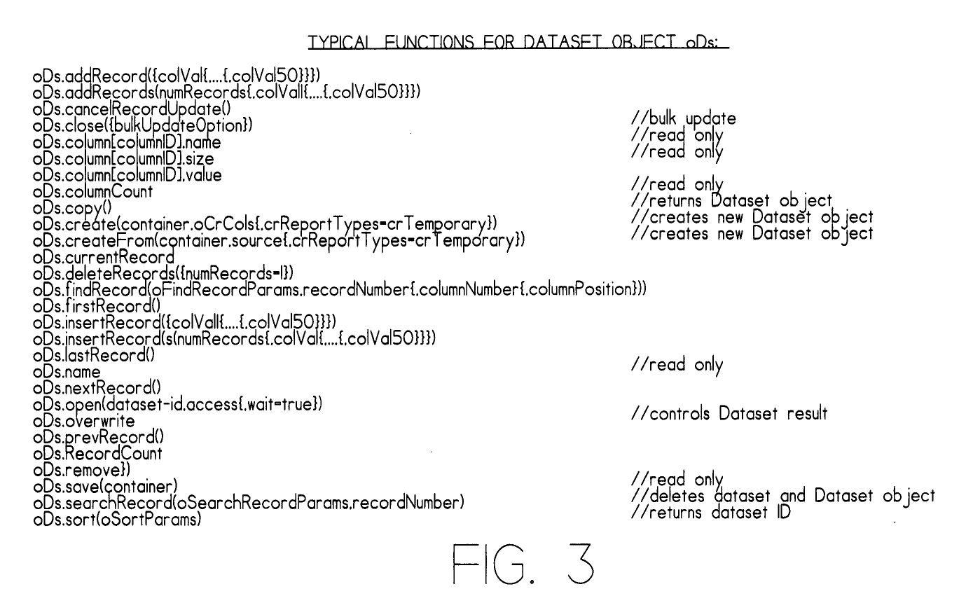

FIG. 3 is a listing of typical dataset object methods and properties.

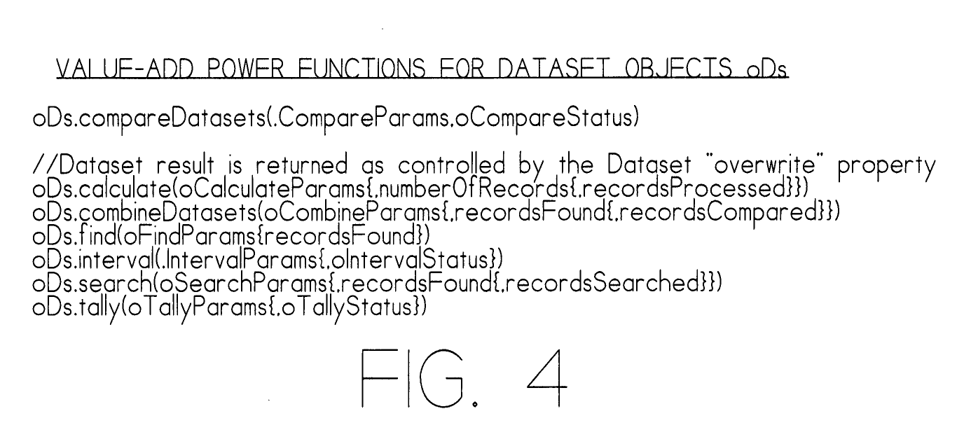

FIG. 4 is a listing of the script for value-add power methods. Many of the functions can use bulk update processing. In the example shown, the search power function is used for illustration purposes.

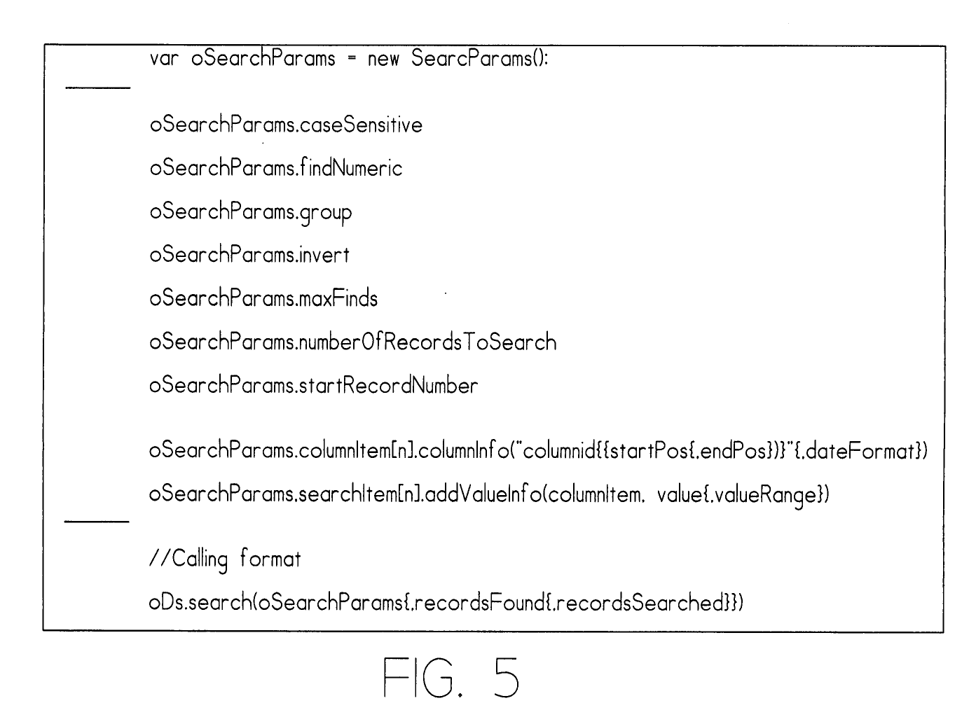

FIG. 5 is a listing of a typical search parameter object. Other power methods have compatible parameter objects. The arguments are programmed in terms of a standardized object-based programing language, such as JavaScript. Parameters to tailor the overall processing are programmed using “root” properties of the Parameter object. For example, the Search Params “invert” property controls whether the resulting search records are those that match or those that do not match the specified column/value criteria.

Related attributes for a particular argument are programmed as a coherent set. For example, the columnInfo( ) method of the columnItem[ ] compound object of the SearchParams object allows the programmer to specify all of the necessary parameterization for a column to be used in the search( ) power method. In this case the parameterization includes the identity of a column to be searched, along with an optional date format. For example:
.SearchParams.columnItem[1].columnInfo(“col1”,dtYYYMMDD)

Similarly, the addValueInfo( ) method of the searchItem[ ] compound object of the SearchParams object allows the programmer to specify all of the necessary parameterization for an item to be searched:
oSearchParams.searchItem[1].addValue(1,20000101,20001231)
   The parameterization includes the identity of the column in terms of its columnItem[ ] index (argument 1) along with the value and optional range value for the matching. A given column Item [ ] index array may be re-used in other search items without having to re-program the column specifications.

In the case of the search( ) power method, up to 80 columns and up to 5 search items can be programmed. Each search item allows up to 25 values to be specified such that a record is considered to match if it matches all values for any given search item. In effect the values for a given search item are processed as an AND condition and the set of search items are processed as an OR condition.

Programming up to 80*5*25 parameters is much more easily accommodated using the SearchParams object rather than the procedural MAPPER run-script. The other MAPPER power method Parameter objects include: calculate( ); combineDatasets( ); compareDatasets( ); find( ); findRecord( ); interval( ); searchRecord( ); sort( ); and tally( ). Each of the Dataset object power method receives the parameterization arguments as a specific Parameter object that has been programmed with the desired criteria.

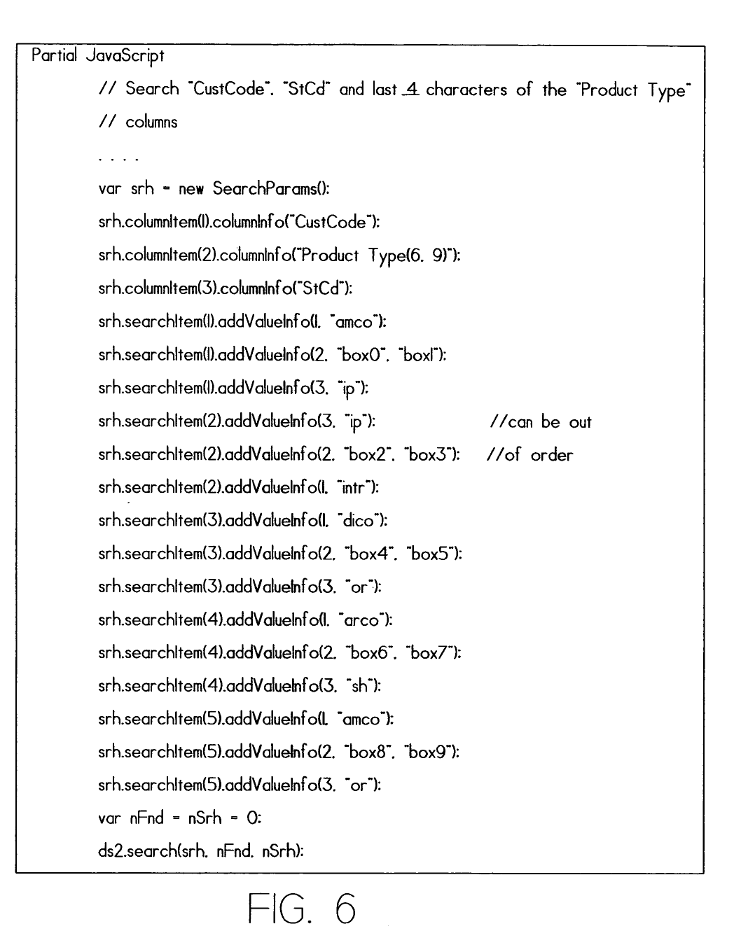

FIG. 6 is a listing of the JavaScript definition for the sample search activity.

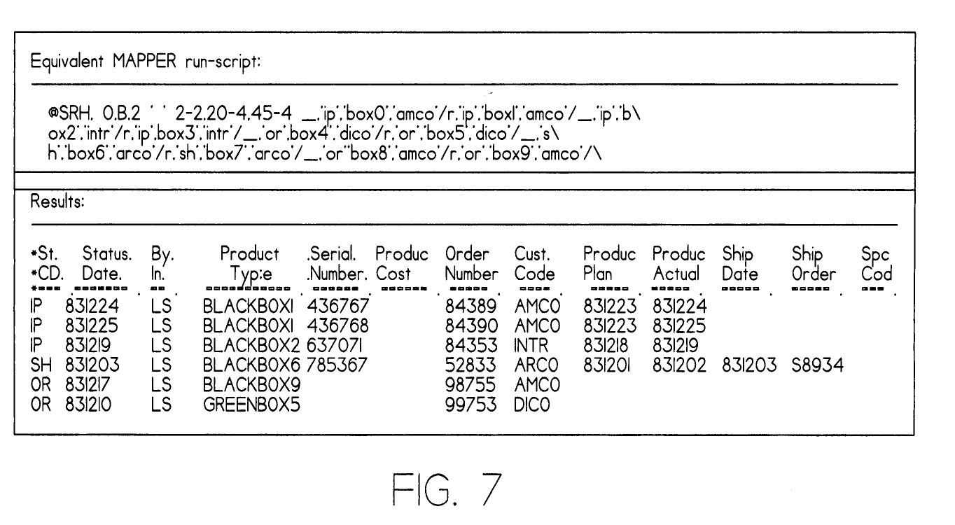

FIG. 7 show the equivalent BIS Script SRH statement to perform the search defined by the JavaScript of FIG. 19. Also shown is the resultant MAPPER report which provides the output of the requested search process.

As is apparent from this example, programming this search activity is straightforward using the SearchParams object, as has been discussed above.

Having thus described the preferred embodiments of the present invention, those of skill in the art will be readily able to adapt the teachings found herein to yet other embodiments within the scope of the claims hereto attached.

1. An apparatus comprising:
a. a user terminal which generates a user request in a standardized object-based command language;
b. a legacy data base management system responsively coupled to said user terminal which honors said user request by execution of a non-standardized command language;
c. a conversion facility for conversion of said standardized object-based command language to said non-standardized command language; and
d. a parameter object responsively coupled to said legacy data base management system which provides definitions for honoring of said user request by said legacy data base management system.

2. The apparatus of claim 1 wherein said user terminal is coupled to said legacy data base management system via a publically accessible digital data communication network.

3. The apparatus of claim 2 wherein said parameter object is defined by said standardized object-based command language.

4. The apparatus of claim 3 wherein said publically accessible digital data communication network further comprises the Internet.

5. The apparatus of claim 4 wherein said standardized object-based command language further comprises JavaScript.

6. A method of utilizing a user terminal to access a legacy data base management system employing a non-standardized command language comprising:
a. transmitting a service request in a standardized object-based command language from said user terminal requesting access to said legacy data base management system;
b. receiving said service request by said legacy data base management system;
c. converting said service request in said standardized object-based command language into said non-standardized command language;
d. accessing a parameter object by said legacy data base management system; and
e. honoring said service request by executing said non-standardized command language by said legacy digital data base management system.

7. A method according to claim 6 wherein said parameter object is initially defined in said standardized object-based command language.

8. A method according to claim 7 wherein said transmitting step occurs over a publically accessible digital data communication network.

9. A method according to claim 8 wherein said publically accessible digital data communication network further comprises the Internet.

10. A method according to claim 9 wherein said standardized object-based command language further comprises JavaScript.

11. An apparatus comprising:
a. permitting means for permitting a user to transfer a service request defined by a standardized object-based command language;
b. offering means responsively coupled to said permitting means via said publically accessible digital data communication network for offering legacy data base management services involving access to at least one data base having a non-standard scripted command language;
c. converting means responsively coupled to said offering means for converting said service request from said standardized object-base command language to said non-standardized scripted command language; and
d. maintaining means responsively coupled to said offering means for maintaining a parameter object.

12. An apparatus according to claim 11 wherein said maintaining means further comprises means said standardized object-based command language.

13. An apparatus according to claim 12 further comprising means located within said permitting means for generating a second service request.

14. An apparatus according to claim 13 wherein said offering means further comprises MAPPER data base management system.

15. An apparatus according to claim 14 wherein said permitting means further comprises an industry standard personal computer.

16. In a data processing system having a user terminal which generates a service request in a standardized object-based command language responsively coupled to a legacy data base management system which honors said service request by executing a non-standardized command language, the improvement comprising:
a. a conversion facility responsively coupled to said legacy data base management system which converts said service request from said standardized object-based command language to said non-standardized command language; and
b. a parameter object responsively coupled to said legacy data base management system which assists said legacy data base management system in honoring said service request.

17. The improvement according to claim 16 wherein said parameter object is defined by said standardized object-based command language.

18. The improvement according to claim 17 wherein said user terminal is responsively coupled to said legacy data base management system via a publically accessible digital data communication network.

19. The improvement according to claim 18 wherein said publically accessible digital data communication network further comprises the Internet.

20. The improvement according to claim 19 wherein said standardized object-based command language further comprises JavaScript.

21. An apparatus for accessing a database comprising:
a. a user terminal which generates a user request in a JavaScript like standardized object-based command language;
b. a legacy data base management system responsively coupled via a publically accessible digital data communication network to said user terminal which honors said user request by execution of a non-standardized command language;
c. a conversion facility for conversion of said standardized object-based command language to said non-standardized command language; and
d. a parameter object defined by said standardized object-based command language responsively coupled to said legacy data base management system which provides definitions for honoring of said user request by said legacy data base management system.
